(19) United States
(12) Patent Application Publication
(10) Pub. No.: US 2010/0217433 A1
(43) Pub. Date: Aug. 26, 2010

(54) STORE MANAGEMENT SYSTEM CAPABLE OF SWITCHING BETWEEN MANNED OR UNMANNED SALES

(76) Inventor: Hyun Dong Son, Daejeon (KR)

Correspondence Address: CHRISTOPHER PAUL MITCHELL, 888 16TH ST., NW, SUITE 800, WASHINGTON, DC, 20006, US

(21) Appl. No.: 12/738,630

(22) PCT Filed: Oct. 15, 2008
(86) PCT No.: PCT/KR08/06053

§ 371 Date: Apr. 16, 2010

(30) Foreign Application Priority Data
Oct. 16, 2007 (KR) 10-2007-0104260
May 7, 2008 (KR) 10-2008-0042099

(51) Int. Cl. G06F 17/00; G09F 19/22; G06Q 30/00; G06Q 20/00

(52) U.S. Cl. 700/234; 700/232; 40/601

(57) ABSTRACT

Disclosed is a store management system capable of switching between manned or unmanned sales. During the daytime, a clerk or owner stays in a store to allow a customer, who visits the opened store, to purchase goods which are received in a vending machine or are displayed in a showcase. On the other hand, in a state wherein the store is closed at night to provide no reception or store management of the clerk or owner, the customer is able to select and order goods of the vending machine at the outside of a show window of the store using a display device and an ordering/settlement device installed at the show window. The vending machine is operated to dispense the selected goods as soon as the customer pays for the goods, and the dispensed goods are discharged out of the show window via a goods discharge device, such as a conveyor belt, to thereby be provided to the customer. When the store management system is applied to stores in areas with heavy pedestrian traffic, efficient sales even at night are possible without manned management by a clerk or owner.

### TECHNICAL FIELD

The present invention relates to a store management system capable of switching between manned or unmanned sales, and more particularly, to a store management system capable of switching between manned or unmanned sales, wherein a clerk or owner stays in a store during the daytime to allow a customer, who visits the opened store, to purchase goods which are received in a vending machine or are displayed in a showcase, whereas, in a state wherein the store is closed at night to provide no reception or store management of the clerk or owner, the customer is able to select and order goods of the vending machine at the outside of a show window of the store using a display device and an ordering/settlement device installed at the show window, the vending machine being operated to dispense the selected goods as soon as the customer pays for the goods and the dispensed goods being discharged out of the show window via a goods discharge device, such as a conveyor belt, to thereby be provided to the customer.

### BACKGROUND ART

Conventionally, switchable unmanned selling systems have been developed to enable efficient store management at minimal cost and without limits in time and labor. For example, with the use of a conventional switchable unmanned selling system, a store can be switched to an unmanned sales manner after normal business hours passes. The conventional switchable unmanned selling system is designed to enable a customer to enter a store even at night without requiring reception of a clerk to thereby purchase goods received in a vending machine provided in the store. In this case, it is necessary to displace the vending machine in the store in such a manner that the vending machine is mainly positioned in close contact with an inner wall of the store during the daytime, but is moved or rotated at night to serve as a barricade. The vending machine, serving as a barricade, is able to divide the interior space of the store into a customer space and an owner space (in which a showcase for daytime selling is provided or a customer is allowed to freely access and take goods or other implements).

However, the above-described conventional switchable unmanned selling system has a problem of low utility in the interior space of a store because the interior space must be sacrificed to some extent for movement or rotation of a switching system, i.e. the vending machine. Furthermore, the conventional switchable unmanned selling system cannot prevent a malicious customer from entering the store to destroy implements in the store or steal goods and the like and thus, is disadvantageous in view of management.

In addition, the above-described conventional switchable unmanned selling system is insufficient to appeal an advantage of a completely unmanned selling system that allows a customer to see or purchase exhibited goods without a psychological burden. In fact, the main type of switchable unmanned selling system is configured such that a plurality of vending machines is simply arranged in a store to spatially construct an unmanned sales set.

### DISCLOSURE OF INVENTION

### Technical Problem

Therefore, the present invention has been made in view of the above problems, and it is an object of the present invention to provide a novel store management system capable of switching between manned or unmanned sales, wherein a clerk or owner stays in a store during the daytime to sell goods exhibited in the store in a manned or unmanned sales manner, whereas after normal business hours, selling of goods in an unmanned sales manner is possible even in a closed state of the store without requiring reception or remote management of the clerk or owner.

It is another object of the present invention to provide a novel store management system capable of switching between manned or unmanned sales, which can assure simplified economic switching between manned or unmanned sales while eliminating difficulties in unmanned store management and security of conventional unmanned selling systems that allow a person to enter a store, and is applicable, without substantial cost, to stores in areas with heavy pedestrian traffic owing to a completely novel unmanned selling manner thereof.

### Technical Solution

In accordance with an aspect of the present invention, the above and other objects can be accomplished by the provision of a store management system capable of switching between manned or unmanned sales comprising: a vending machine installed in a store; a display device installed at a show window of the store and used to display images of goods, which are sold in the vending machine, on the exterior of the show window; an ordering/settlement device installed at the exterior of the show window and used to allow a customer to order the goods, displayed via the display device, and settle the price of the ordered goods with cash or a credit card; and a goods discharge device to discharge the goods, which are dispensed from the vending machine as soon as the customer pays for the goods, out of the store so as to provide the customer with the goods, wherein the customer purchases the goods of the vending machine within the store during the daytime, but purchases goods at the outside of the store at night.

The display device may be vertically or horizontally folded or unfolded inside the show window such that the display device is kept in an upwardly folded (wound) state at the upper end of the show window during the daytime, and is unfolded to face the exterior of the show window at night.

The display device may take the form of a thin display panel, which is embedded in the show window or is attached to an inner or outer surface of the show window, whereby the display device functions as a transparent show window during the daytime, and displays images of goods on the exterior of the show window upon receiving power at night.

The goods discharge device may include: a controller to transmit a signal required to manipulate the vending machine in which goods are received, on the basis of a signal from the ordering/settlement device; and a transfer unit to transfer the goods, dispensed from the vending machine under operation of the controller, to the outside of the show window. The transfer unit may be selected from among a belt type conveyor, a roller type conveyor, a pneumatic duct type conveyor, and a transfer robot. In addition to the listed transfer methods, other transfer methods in which the transfer of goods provides the customer with interest and curiosity may be used so long as the transfer methods have no risk of damage to goods during transfer.

With relation to selecting methods of goods, the customer may use keyboard buttons or a touch-screen type monitor of the ordering/settlement device, or may directly select goods using the display device installed at the show window. The customer is able to subsequently perform the ordering and settlement of goods under the assistance of voice guidance from the ordering/settlement device, or images or characters displayed on a monitor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view schematically showing unmanned management of a store at night according to a first embodiment of the present invention;

FIG. 2 is a perspective view schematically showing manned management of the store during the daytime according to the first embodiment of the present invention;

FIG. 3 is a plan view of the unmanned store shown in FIG. 1;

FIG. 4 is a plan view of the unmanned store shown in FIG. 2;

FIG. 5 is a side sectional view of the unmanned store;

FIG. 6 is a front view of the store during night management; and

FIG. 7 is a side sectional view and an enlarged view of an important part of an unmanned store according to a second embodiment of the present invention.

### BEST MODE FOR CARRYING OUT THE INVENTION

Hereinafter, exemplary embodiments of the present invention, which are not intended to limit the scope of the present invention, will be described in detail with reference to the accompanying drawings.

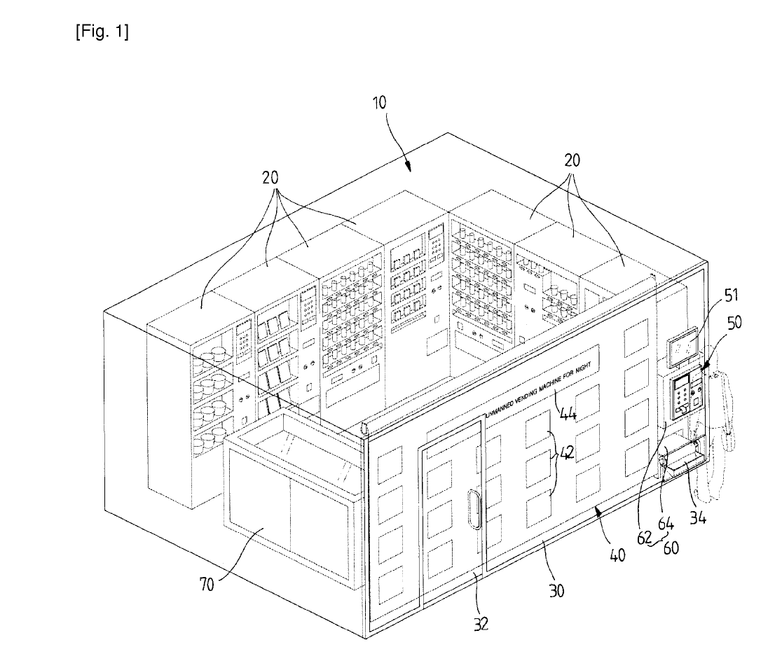

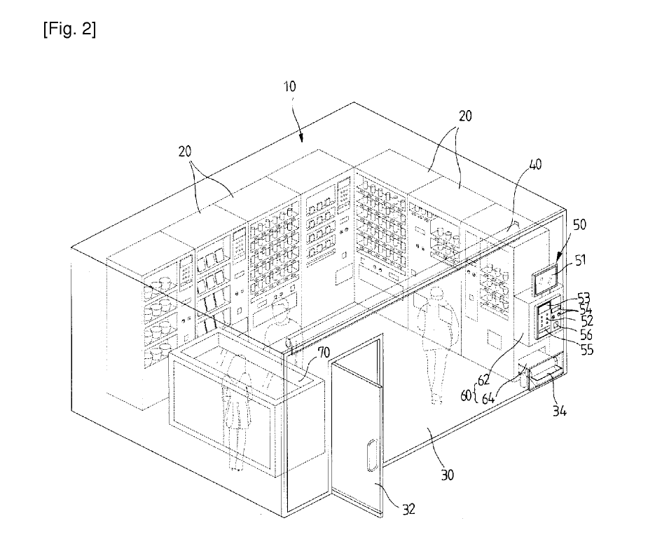

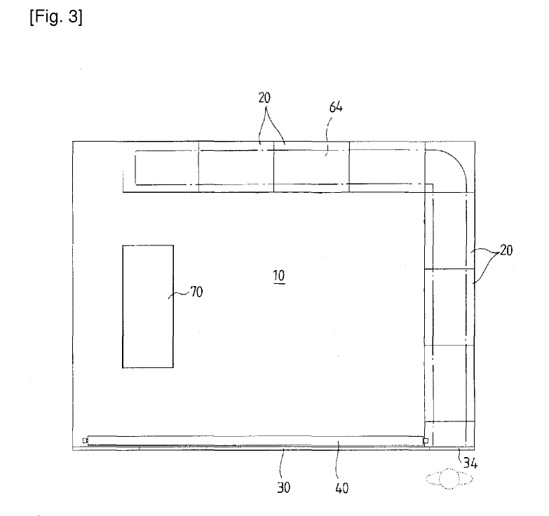

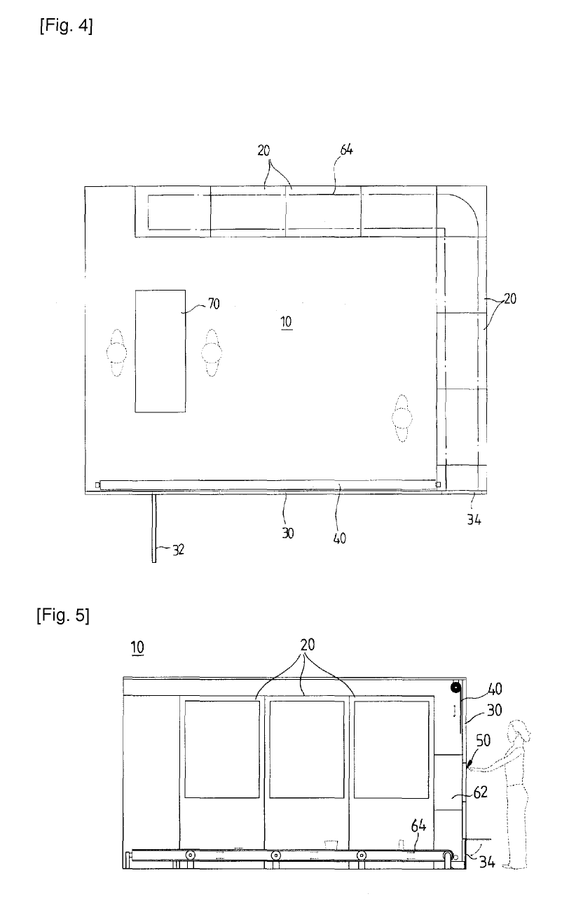

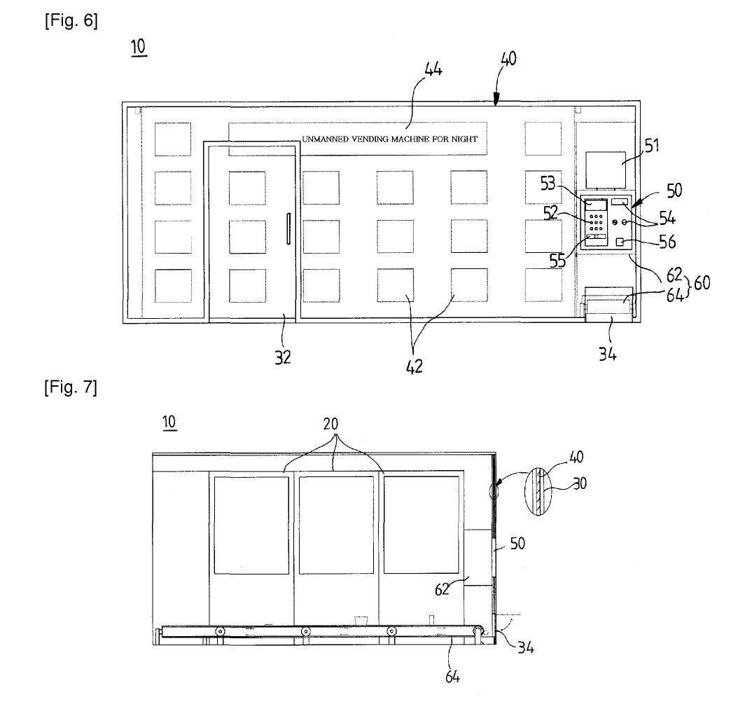

FIGS. 1 to 6 illustrate a store according to a first embodiment of the present invention. More particularly, FIGS. 1 and 2 schematically illustrate, respectively, an unmanned management manner at night and a manned management manner during the daytime. FIGS. 3 and 4 are plan views of FIGS. 1 and 2, respectively. FIG. 5 is a side sectional view of the store, illustrating a configuration of a transfer device, and FIG. 6 is a front view of the store, showing display of images of goods for unmanned store management at night.

As shown in FIGS. 1 to 6, a store management system capable of switching between manned or unmanned sales according to the present embodiment includes: vending machines 20 installed in a store 10; a display device 40 installed at a show window 30 of the store 10 and used to display images of goods, which are sold in the vending machines 20, on the exterior of the show window 30 at night; an ordering/settlement device 50 installed at the exterior of the show window 30 and used to allow a customer to order the goods, displayed via the display device 40, and settle the price of the ordered goods with cash or a credit card; and a goods discharge device 60 to discharge the goods, which are dispensed from the vending machines 20 or a goods storehouse as soon as the customer pays for the goods using the ordering/settlement device 50, out of the store 10 so as to provide the customer with the goods. With this configuration, the customer purchases goods of the vending machines 20 within the store during the daytime, but purchases goods at the outside of the store at night.

In the drawings, reference numeral 32 designates an entrance/exit door of the store 10. The entrance/exit door 32 is opened during the daytime, but is closed using a locking device at night. Also, reference numeral 34 designates a goods discharge opening through which goods are discharged.

Although the term “store” as described herein may typically represent an individual shop, the present invention is not limited thereto, and the store may be analyzed to a part of a business section containing plural stores or the entire business section. Hereinafter, for convenience of description, only the exemplary embodiments wherein a single store can be switched between manned or unmanned sales will be described.

In addition, it is noted that the term “daytime” as described herein does not indicate a dictionary definition of “daytime”, but represents a normal business time from about 9:00 a.m. to about 9:00 p.m., and the term “night” indicates all other times. Of course, the use of these terms does not limit the scope of the present invention that will be described hereinafter.

In the present invention, to allow many customers to enter the store 10 during the daytime (i.e. during the normal business hours) for efficient selling of goods, the plurality of vending machines 20 may be arranged in close contact with a wall surface. The goods discharge device 60 is installed immediately below the vending machines 20 at a position so as not to be visible from the outside of the vending machines 20. The goods discharge device 60 may be a conventional conveyor belt, and has a distal portion connected to the goods discharge opening 34 provided at a position of the show window 30.

In addition to the vending machines 20, a show case 70, in which a variety of goods are displayed, is installed in the store 10, to allow a clerk or owner to directly show and sell goods to the customers. As shown, the show case 70 may be disposed at a spatially independent position of the vending machines 20 in various manners.

Of course, other goods display devices, structures and the like except for the vending machines 20 and show case 70 shown in the drawings may be additionally provided in the store 10.

Here, the vending machine 20 may be a conventional vending machine, or may be a modified vending machine combined with the goods discharge device according to the present invention. The kinds of goods to be sold in the vending machines may be selected from a variety of goods in consideration of conditions or location of the store, and generally include beverages, fast-food, clothes, accessories, and other various daily necessities.

In the present embodiment, the display device 40 is configured to be vertically folded or unfolded inside the show window 30. Specifically, the display device 40 is kept in an upwardly folded (wound) state at the upper end of the show window 30 during the daytime as shown in FIG. 2, and is unfolded (unwound) to cover the entire show window 30 at night as shown in FIG. 1. In the unfolded state, the display device 40 serves to display images of goods and advertisements and the like on the exterior of the show window 30.

In the present invention, the installation site of the display device 40 is not limited to the single-sided show window 30 as shown in the drawings. For example, in the case of a store having a multiple sided show window 30, the display device 40, ordering/settlement device 50 and goods discharge device 60 may be installed and managed on a per show window side basis.

In the present embodiment, the display device 40 takes the form of a winding type roll screen. The display device 40 in the form of a roll screen is provided at a surface thereof with a plurality of goods display sections 42. The plurality of goods display sections 42 is arranged vertically and horizontally and is used to display visual images or real samples, prices and the like of goods being sold (i.e. goods to be purchased in an unmanned sales manner). The display device 40 is further provided at an upper center portion thereof with an advertisement section 44. The advertisement section 44 may be printed with advertisements and the like, or may include an electric bulletin board.

The goods display sections 42 are preferably arranged such that they are vertically or horizontally linked according to the kinds (categories) of goods. A backlight unit or other exterior illuminators may be provided to irradiate light to the individual goods display sections 42 or all of the goods display sections 42. Accordingly, it is possible to easily visually confirm the images displayed in the goods display sections 42 of the display device 40 at night from the outside of the store 10 and furthermore, is possible to easily recognize the position and condition of the store 10 from a distance.

The goods display sections 42 may be directly printed on the roll screen, or photographs of goods or films printed with images of goods may be attached to the respective goods display sections 42.

In addition to displaying images and prices of goods, the display device 40 may be configured in such a manner to allow the customer to directly select and order goods using the display device 40. For this, the display device 40 may be provided with sensors (not shown) at the respective goods display sections 42, allowing the customer to order goods with his/her hands or other tools.

The display device 40 in the form of a roll screen may be designed such that it is fixedly kept in an unwound state thereof, or may be designed dynamically such that it is slowly movable vertically in an endless manner to allow the customer to conveniently select desired goods at the same height as the customer's eyes.

The store of the present invention has difficulty in the installation of an anti-crime shutter at the exterior of the show window 30 and therefore, requires installation of the anti-crime shutter inside the show window 30. When the display device 40 is integrally formed with the shutter, it is possible to prevent breakage of the show window 30 and thus, to prevent unexpected accidents, such as robbery or breakage of implements by trespass.

The ordering/settlement device 50 is installed at the exterior of the show window 30. The ordering/settlement device 50 basically includes a monitor 51 to show goods to be purchased in the same manner as the display device 40 or to inform of goods ordering and settlement methods, buttons 52 for selection of goods and settlement methods, a price display window 53, cash/credit card input slots 54, a receipt output 55, and a cash balance refund exit 56.

The monitor 51 serves to display goods being sold in the vending machines 20 by item. If the monitor 51 takes the form of a touch screen to allow the customer to select and order goods displayed on the monitor 51, more convenient ordering of goods by the customer can be assured.

The goods discharge device 60 is configured to discharge goods, which are dispensed from the vending machines 20 when the customer completes the settlement of the goods using the ordering/settlement device 50, out of the store 10 so as to provide the customer with the goods. The goods discharge device 60 includes a controller 62 to transmit a signal required to manipulate a specific vending machine 20 in which the ordered goods are received, on the basis of a signal from the ordering/settlement device 50, and a transfer unit 64 to transfer the goods, dispensed from the vending machine under operation of the controller 62, to the outside of the show window 30. The transfer unit 64 is installed below discharge chutes of the respective vending machines 20. Accordingly, if the goods ordered by the customer are dropped from the discharge chutes to the transfer unit 64, the transfer unit 64 receives and transfers the dropped goods out of the show window 30. The transfer unit 64 takes the form of a conveyor belt.

FIG. 7 is a side sectional view and an enlarged view of an important part of an unmanned store according to a second embodiment of the present invention. The store according to the present embodiment is basically identical to the first embodiment, except that the display device 40 installed at the show window 30 takes the form of a thin display panel, rather than the roll screen. The display device 40 in the form of a thin display panel may be embedded in the show window 30 as shown, or may be attached to an inner surface of the show window 30. The display device 40 of the present embodiment functions as a transparent show window during the daytime, but serves to display images of goods on the exterior of the show window 30 upon receiving power at night.

In fact, although the thin display panel used in the present embodiment currently has high installation costs, it is expected that the thin display panel has greater outstanding effects than the above-described roll screen if the thin display panel is lowered in price in the near future.

In management of the present invention having the above-described configuration, generally, a clerk or owner stays in the store 10 during the daytime, and the customer is allowed to freely access the store 10 through the entrance/exit door 32 so as to purchase goods that are received in the vending machines 20 or are exhibited in the show case 70.

On the other hand, at night, without requiring management by the clerk or owner, the store is managed in an unmanned manner in a state wherein the entrance/exit door 32 of the store 10 is closed. In this case, the customer having an intention to purchase goods can select goods at the outside of the show window 30 while seeing images of the goods on the display device 40 provided at the show window 30. Then, as soon as the customer pays for the goods using the ordering/settlement device 50, the selected goods are dispensed from the vending machines 20 provided in the store 10 and are discharged from the goods discharge opening 34 at the exterior of the show window 30 under operation of the goods discharge device 60 including the conveyor belt.

Accordingly, when the store management system of the present invention is applied to stores in areas with heavy pedestrian traffic, efficient sales even at night are possible without manned management by a clerk or owner.

### INDUSTRIAL APPLICABILITY

As apparent from the above description, a store management system capable of switching between manned or unmanned sales according to the present invention has a more simplified configuration and easier installation than conventional switchable unmanned selling systems. Further, the store management system of the present invention has advantages of superior maintenance and security characteristics. When the store management system is applied to stores in areas with heavy pedestrian traffic, efficient sales even at night are possible without manned management by a clerk or owner.

1. A store management system capable of switching between manned or unmanned sales comprising:
a vending machine installed in a store;
a display device installed at a show window of the store and used to display images of goods, which are sold in the vending machine, on the exterior of the show window;
an ordering/settlement device installed at the exterior of the show window and used to allow a customer to order the goods, displayed via the display device, and settle the price of the ordered goods with cash or a credit card; and
a goods discharge device to discharge the goods, which are dispensed from the vending machine as soon as the customer pays for the goods, out of the store so as to provide the customer with the goods,
wherein the customer purchases the goods of the vending machine within the store during the daytime, but purchases goods at the outside of the store at night.

2. The store management system according to claim 1, wherein the display device is vertically folded or unfolded inside the show window such that the display device is kept in an upwardly folded (wound) state at the upper end of the show window during the daytime, and is unfolded to display images of goods or real samples on the exterior of the show window at night.

3. The store management system according to claim 1, wherein the display device takes the form of a thin display panel, which is embedded in the show window or is attached to an inner surface of the show window,
whereby the display device functions as a transparent show window during the daytime, and displays images of goods on the exterior of the show window upon receiving power at night.

4. The store management system according to claim 1, wherein the goods discharge device includes: a controller to transmit a signal required to manipulate the vending machine in which goods are received, on the basis of a signal from the ordering/settlement device; and a transfer unit to transfer the goods, dispensed from the vending machine under operation of the controller, to the outside of the show window.
